(19) United States
(12) Patent Application Publication
(10) Pub. No.: US 2013/0024818 A1
(43) Pub. Date: Jan. 24, 2013

(54) Apparatus and Method for Handling Tasks Within a Computing Device

(71) Applicants: Roope Rainisto, Helsinki (FI); Martin Schule, Tampere (FI); Mox Soini, Helsinki (FI)

(72) Inventors: Roope Rainisto, Helsinki (FI); Martin Schule, Tampere (FI); Mox Soini, Helsinki (FI)

(73) Assignee: NOKIA CORPORATION, Espoo (FI)

(21) Appl. No.: 13/318,292

(22) PCT Filed: Apr. 30, 2009
(86) PCT No.: PCT/FI09/50344

§ 371 Date: Apr. 13, 2012

(51) Int. Cl. G06F 3/048

(52) U.S. Cl. 715/838

(57) ABSTRACT

A task manager for a computing device which provides a user interface to the currently running tasks on the computing device. The user interface comprises a representation for each task which is a reduced size version of the display which would be visible to the user if that task were in the foreground. Preferably, the task manager sets out the representations so that no more than a maximum number of representations is visible at one time.

### TECHNICAL FIELD

Embodiments relate generally to computing devices and, more particularly, to handling tasks within a computing device.

### BACKGROUND

Computing devices comprise hardware and software components. The software generally includes an operating system and applications, as well as other software components. The operating system regulates interaction between applications and the hardware components. A user then interacts with the computing device through one or more of the applications by means of the operating system.

In the past, operating systems were only able to run a single user application at a time and, if a user wished to utilise another application, it was necessary to terminate the currently-open application. Nowadays however operating systems are multi-tasking and are able to run a number of user applications simultaneously by means of a process known as a “multi-threading”. In certain examples, the term “task” refers to any application which is currently running, or the running of which has been suspended.

Multi-tasking operating systems have allowed users to perform a number of simultaneous operations using a single computing device and quickly transfer information between applications running on the device. However, a proliferation of applications can cause a confusing operating environment. In particular, where a number of applications are simultaneously running on a device, generally only one of these applications will be available for interaction with the user. In certain examples, an application in this state is generally referred to as being in the “foreground”, whereas other applications are referred to as being in the “background”. Background applications are not necessarily suspended (although they may be) and the operating system ensures that any processing required for these background applications will continue to occur, albeit at a lower priority than the foreground application. In certain operating systems, only the foreground application is visible to the user and only a single application may be in the foreground at any one time.

In this respect, it is relevant that the processing involved in launching an application is significantly greater than that involved in switching an application between a background mode and a foreground mode. The confusion arises when a user has a number of currently-running applications, but only one of these (or a subset of all running applications) is visible. Therefore, unless a user interface is provided which allows the user to distinguish between currently-running applications and applications which are not currently running, it is necessary for the user to remember which applications were previously launched and which ones have not been launched, in order to avoid the frustration of encountering an unexpected wait when selecting an application.

Therefore, in certain situations, a user is presented with two distinct user interfaces; one allowing the user to select an application to be launched and another allowing a user to select an application which has already been launched and which is currently in a background mode which, on selection, is then switched to a foreground mode.

### SUMMARY OF EMBODIMENTS

An embodiment provides an apparatus comprising a task manager and a display, said task manager being configured to:
designate a predetermined display area for displaying representations of tasks on said display; and
display a representation of each of a plurality of tasks in said predetermined display area, wherein each of said representations is a representation of a display caused by said corresponding task, and wherein no more than a predetermined maximum number of representations is displayed in said predetermined display area.

A further embodiment provides a method of representing a plurality of active tasks in a computing device said computing device having a display, said method comprising:
designating a predetermined display area for displaying representations of tasks on said display; and
displaying a representation of each of a plurality of tasks in said predetermined display area, wherein each of said representations is a representation of a display caused by said corresponding task, and wherein no more than a predetermined maximum number of representations is displayed in said predetermined display area.

A further embodiment provides a memory medium storing a computer program executable by a processor of a computing device, said computing device having a display and a plurality of tasks operating thereon, said computer program performing operations when executed by said processor, said operations comprising:
designating a predetermined display area for displaying representations of said tasks on said display; and
displaying a representation of each of a plurality of tasks in said predetermined display area, wherein each of said representations is a representation of a display caused by said corresponding task, and wherein no more than a predetermined maximum number of representations is displayed in said predetermined display area.

A further embodiment provides a task manager for use in a computing device having a plurality of tasks, said task manager being configured to display an icon for each of said plurality of tasks over one or more pages where each page holds no more than a predetermined maximum number of icons, wherein a size of said icons for a page is dependent on the number of icons displayed on that page.

Embodiments provide a user interface which presents no more than a predetermined maximum number of representations of tasks to the user where each representation is a representation of a display which is caused by the corresponding task. In this manner, the size of the representation is able to vary in dependence on the number of representations displayed, but is prevented from being reduced beyond a predetermined minimum size. This helps to ensure that a user is able to recognise the task by the corresponding representation.

### BRIEF DESCRIPTION OF THE DRAWINGS

Embodiments are hereinafter described with reference to the accompanying diagrams where:

FIG. 1 is a schematic representation of a mobile computing device wherein embodiments are implemented;

FIG. 2 is a schematic diagram illustrating the arrangement of hardware components of the computing device of FIG. 1;

FIG. 3 is a schematic diagram illustrating the arrangement of hardware and software components of the computing device of FIG. 1 when arranged according to an embodiment;

FIG. 4 is a further schematic representation of the mobile computing device of FIG. 1;

FIGS. 5 to 8 are task manager views according to an embodiment;

FIG. 9 is a flow diagram illustrating the operation of the embodiment of FIGS. 5 to 8.

FIG. 10 is a further task manager view according to an embodiment;

FIG. 11 is a flow diagram illustrating the operation of the embodiment of FIG. 10;

FIG. 12 is a further task manager view according to an embodiment; and

FIG. 13 is a flow diagram illustrating the operation of the embodiment of FIG. 12.

### DESCRIPTION OF EMBODIMENTS

A description of a number of embodiments follows, provided by way of example only.

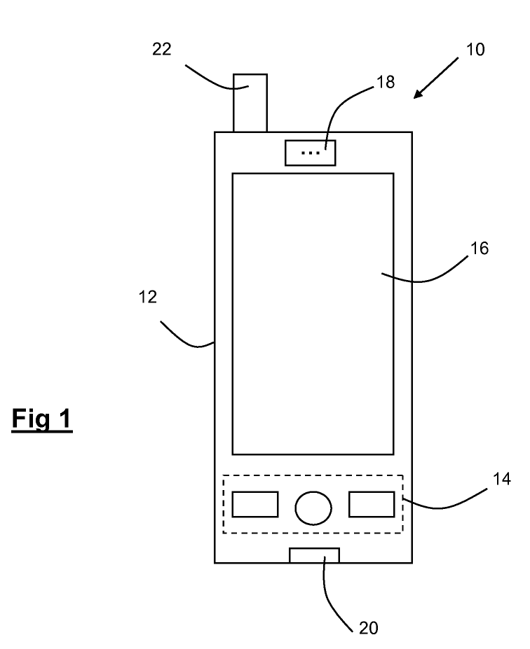

FIG. 1 is a schematic diagram of a computing device 10 having a casing 12. The computing device 10 forms the basis of the embodiments to be described. The casing 12 of the device 10 encapsulates a keypad 14, a touch-screen display 16, a speaker 18 and a microphone 20. The device 10 further includes an antenna 22. The device 10 illustrated in FIG. 1 is a mobile device in that it may be held in a user's hand and used to participate in communication sessions, in particular, telephone calls. During such sessions the device 10 may be utilised so that the speaker 18 is held to a user's ear and the microphone 20 is situated in proximity to a user's mouth.

The device 10 is a computing device which operates as a mobile phone. However, further embodiments relate to other computing devices which do not include telephony as their major function.

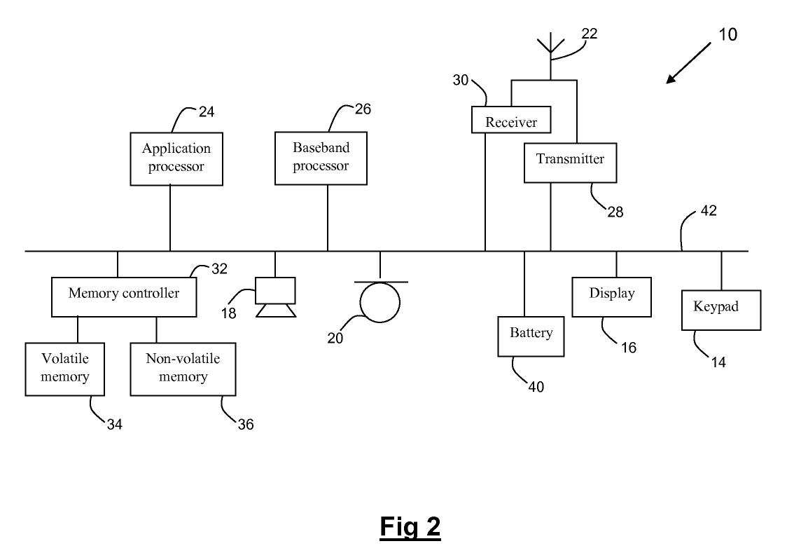

FIG. 2 is a schematic illustration showing the arrangement of the hardware components of the device 10 of FIG. 1. The keypad 14, display 16, speaker 18 and microphone 20 shown in FIG. 1 are connected to a system bus 42. The bus 42 is further connected to an application processor 24, a baseband processor 26, a transmitter 28, a receiver 30 and a battery 40. Transmitter 28 and receiver 30 are connected to the antenna 22. The bus 42 is further connected to a memory controller 32 which is, in turn, connected to volatile memory 34 and non-volatile memory 36. The application processor 24 processes instructions related to various software modules and operating system software which run on the device 10 and which provide various functionality of the device 10. The baseband processor 26 is concerned with the communication functions and to this end controls a telephony stack and communicates with the transmitter 28 and receiver 30 to establish communications by means of the antenna 22. The various processing elements of the device 10 such as the application processor 24 and baseband processor 26 may be provided on a single processor.

Memory controller 32 controls the access to, and interaction with, volatile memory 34 and non-volatile memory 36. In this manner the application processor 24 is able to communicate with the various hardware elements as well as the memory controller 32 and thereby control the operation of the various hardware elements according to software instructions stored on volatile memory 34 or non-volatile memory 36.

Only a single bus, bus 42, is illustrated in FIG. 2. It is to be realised that this bus may be replaced by two or more buses and that the topology of FIG. 2 would vary accordingly. Furthermore, known computing devices include hardware components additional to those illustrated in FIG. 2, but these are well known in the art and are not further described herein.

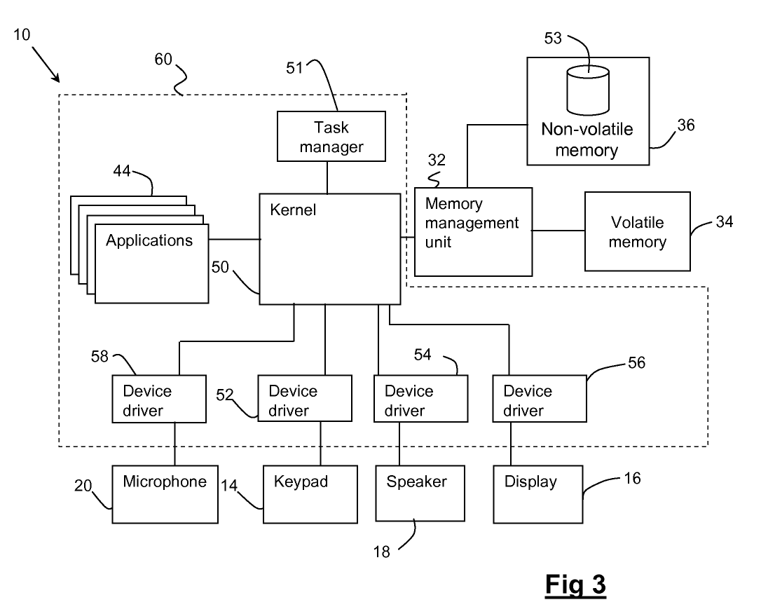

FIG. 3 is a diagram illustrating various hardware and software components of the device 10. The software operating on the device 10 can be categorised in various ways. Certain software operates to manage the resources provided by the various hardware components and to establish an operational environment in which other software executes. This software is known as the operating system of the device and is represented in FIG. 3 by a kernel 50. The kernel 50 interacts with the memory management unit 32 which, as previously described, is connected to volatile memory 34 and non-volatile memory 36. The kernel 50 is further connected to a plurality of applications 44 each of which may access the hardware components in a manner dictated by the kernel 50. The applications 44 are user applications, which may be started and terminated by the user.

The operating system of kernel 50 is a multi-tasking operating system and is capable of simultaneously running a number of the applications 44. When an application 44 is running it is, in this embodiment, referred to as a “task” and it may be in a foreground mode in which case the output from that application is displayed on the display 16 and that application accepts input from the user. Alternatively, the task may be in a background mode where the task does not accept input from the user and the output produced by that task is not necessarily displayed on the display 16.

The kernel 50 allocates processing cycles of the application processor 24 to a task in dependence on whether the task is in a foreground mode or a background model; the foreground task taking precedence over background tasks. If it is determined that a background task needs no, or little, processing power, the kernel may suspend that task by allocating no processing to the task until a user selects that task and brings it to the foreground.

The kernel 50 is further connected to a task manager 51 for helping a user of the device 10 keep track of applications 44 which are running. In the current embodiment, the task manager is concerned with user applications (applications under the control of the user). In a further embodiment, the task manager is concerned with user applications and other processes running in the computing device which produce a visual output.

The kernel 50 is a multi-tasking operating system capable of running more than one application 44 running simultaneously. In the present embodiment, the task manager 51 provides a means by which the user can identify which applications 44 are running and switch between running applications 44. In particular, the task manager 51 is configured to notify the kernel 50 of an application chosen by the user in the manner described below. The kernel 50 can then bring the chosen application to the foreground by, for example, granting it access to control the display 16 and by assigning appropriate processing cycles to the chosen application. While the chosen application is in the foreground, the kernel 50 places all other running applications in the background.

The device 10 further comprises a task manager database 53 stored in non-volatile memory 36. The task manager 51 interacts with the task manager database 53 by means of the kernel 50 and the memory controller 32 in the manner described below.

The kernel 50 is further connected to the keypad 14 by means of device driver 52, to speaker 18 by means of device driver 54 and to the display 16 by means of device driver 56. Only some of the hardware components have been illustrated but, generally, the kernel 50 controls the hardware resources of the device 10 through various device drivers. Furthermore, although the device drivers have been illustrated as separate to the kernel 50, it is possible for them to be incorporated into the kernel 50.

The software components of FIG. 3 are delineated by dashed area 60. However, this distinction between software and hardware is not essential. Components depicted as software in FIG. 3 may be rendered in hardware, and those depicted as hardware may, in certain circumstances, be rendered as software.

During operation of the device, software instructions stored in non-volatile memory 36 establish the kernel 50, the applications 44 and the device drivers 52, 54 and 56. Through the use of the various components illustrated in FIG. 3 a user is able to utilise the device 10 according to the functionality provided by the various applications 44. For example, a user uses the keypad 14 and/or the touch-screen display 16 to communicate with the kernel 50 by means of device drivers 52 and 56 to cause one of the applications 44 to access data stored on non-volatile memory 36 by means of memory management unit 32. The kernel 50 causes the data supplied by memory management unit 32, together with instructions supplied by the application, to be sent to the application processor 24 (FIG. 2). The application processor 24 will return results from the data and instructions, generally utilising volatile memory 34 in the process, and these will be returned to the application by the kernel 50. On further instructions from the application, the kernel 50 will cause the results to be displayed to the user on display 16 by means of device driver 56. It is to be realised that device drivers 52, 54 and 56 are also software components originating from instructions stored on non-volatile memory 36.

The illustration of FIG. 3 is presented merely by way of example; known devices may comprise more components than those shown. Implementations of embodiments are not dependent on the precise arrangement and configuration of components shown in FIGS. 1, 2 and 3. Therefore other components with similar functionality may be substituted and further components added thereto, or illustrated components omitted therefrom, without affecting the operation of embodiments.

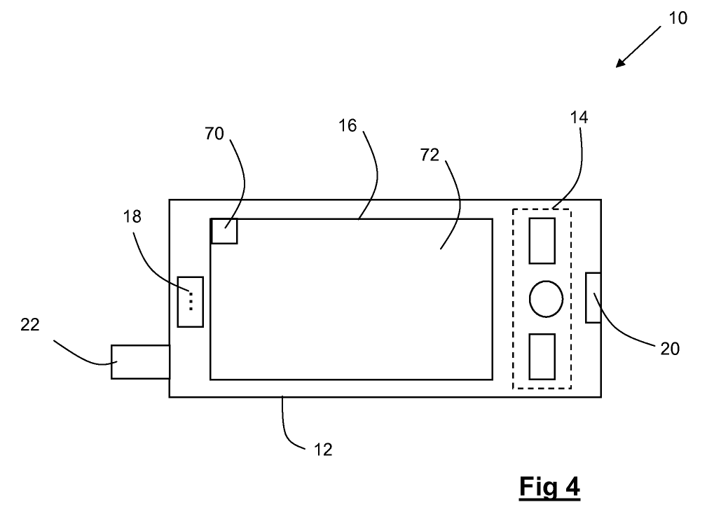

FIG. 4 shows the device 10 of FIG. 1 rotated anti-clockwise through 90 degrees, so that the display 16 is in a landscape orientation. In this orientation, a top-left portion of the display 16 is configured as a button 70. A remaining portion 72 of the display 16 which does not comprise the button 70 provides a conventional display means for the device 10. For example, the remaining portion 72 could display a running application or a desktop (also known as a ‘home view’). The button 70 is linked with the task manager 51 (FIG. 3) and, on operation by a user, brings the task manager into a foreground mode.

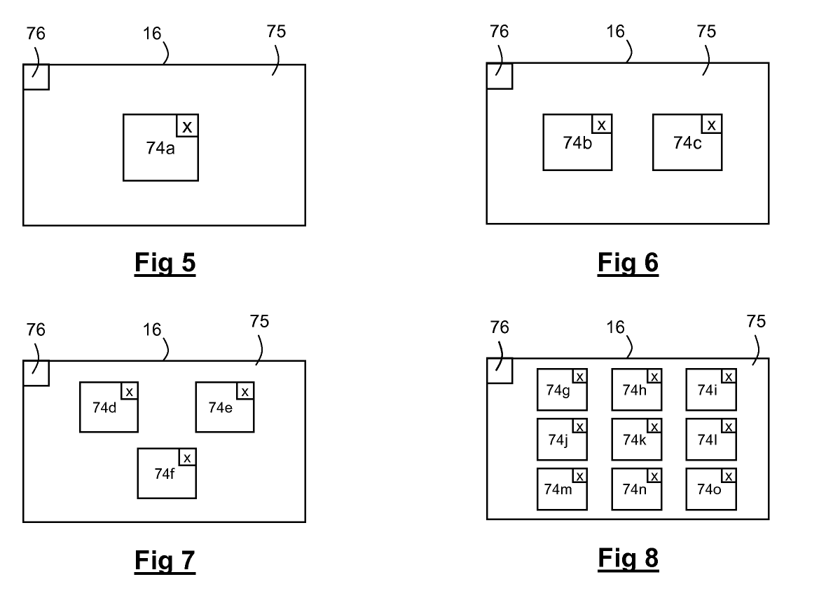

The task manager 51 is similar to the other applications 44 in that the task manager 51 may operate in a foreground mode or in a background mode. When the task manager 51 is in the foreground mode, the task manager view 75 and button 76 are visible (FIGS. 5 to 8, described below). When the task manager 51 is in the background mode, the task manager view is not visible, but the button 70 is visible and accepts input from the user. In this respect, the task manager 51 differs from other applications in that it is able to accept input from the user when in both foreground and background modes.

FIGS. 5 to 8 provide screen shots from the display 16 of the user interface comprising the task manager view 75, according to an embodiment. On activation of the button 70 by suitable means, such as, for example, a user's finger or a stylus, the task manager view 75 is displayed. As described, activation of button 76 switches the task manager 51 from a background mode, wherein the task manager view 75 is not visible on the display 16, to a foreground mode, wherein the task manager view 75 is displayed on the display 16. In the present embodiment, when the task manager view 74 is visible (as shown in FIGS. 5 to 8) it occupies substantially all of the display 16. The task manager view can comprise one or a number of active icons 74a to 74o, each one providing a representation of a task on the device 10. In the present embodiment, the size of the task manager view 75 is independent of the number of active icons displayed thereon.

According to the embodiment illustrated in FIGS. 5 to 8, each active icon 74a to 74o is a representation of a display caused by the application which it relates to. In the embodiment illustrated, the active icons 75a to 75o are reduced size representations of the entire display which would be visible were the corresponding application running in the foreground. In an alternative embodiment, the representation may be a zoomed-in representation of a portion of the display (for example, a centre portion) which would be visible if the corresponding application were running in the foreground. In either case, the representation enables a user of the device 10 to instantly identify a running application by looking at its corresponding representation.

Each of the active icons 74a to 74o contains a top-right portion marked with the symbol ‘x’. The portion of each active icon marked ‘x’ provides a button which the user may use to terminate the application corresponding to the active icon. Furthermore, the task manager views 75 of FIGS. 5 to 8 each contain a button or icon positioned in a top left portion and marked with a reference sign 76. The button 76 takes the place of the button 70 when the task manager 51 is in the foreground mode. Also, the button 76 enables the user to move the notification manager 51 from the foreground mode back to the background mode, wherein the button 70 again takes the place of the button 76.

The representations 74a to 74o are laid out in accordance with layout rules. The layout rules are stored and implemented by the task manager 51. Firstly, the layout rules ensure that all active icons are positioned clearly on the task manager view. Secondly, the layout rules ensure that each active icon is sized to make efficient use of the space available on the task manager view, and thereby make it easy for the user to identify which running application is being represented by each active icon.

In the present embodiment, the layout rules are such that the position and size of each active icon is dependent on the number of active icons displayed. The following explains the implementation of the layout rules to generate FIGS. 5 to 8. FIG. 5 represents a case where there is only one running application, wherein active icon 74a represents the running application. Active icon 74a is sized larger than the active icons of FIGS. 6 to 8, and is positioned in the centre of the task manager view. FIG. 6 represents a case where there are two running applications (a second application has been launched), wherein active icons 74b and 74c represent the two running applications. In this case, it is to be realised that active icon 74b represents the same application as active icon 74a. Active icons 74b and 74c are sized smaller than the active icon in FIG. 5 but larger than those in FIGS. 7 and 8. Also, the active icons are horizontally centred on the task manager view.

FIG. 7 represents a case where there are three running applications, wherein active icons 74d to 74f represent the three running applications (where active icon 74d represents the same application as active icons 74a and 74b of FIGS. 5 and 6, respectively). Active icons 74d to 74f are sized smaller than the active icons in FIGS. 5 and 6 but larger than those in FIG. 8. Also, each row of active icons is vertically centred in the task manager view.

Finally, FIG. 8 represents a case where there are nine running applications, wherein active icons 74g to 74o represent the nine running applications (the same applications being represented here as illustrated in FIGS. 5, 6 and 7). Active icons 74g to 74o are sized smaller than the active icons in FIGS. 5, 6 and 7 to allow all active icons to be represented on the task manager view 75. Also, each row of active icons is centred in the task manager view. In the present embodiment, there is a predetermined maximum number of active icons which can be displayed on the task manager view. In the present embodiment, the maximum number is nine, as illustrated in FIG. 8.

As the number of icons displayed in the task manager view is limited, and the size of the icons varies in dependence on the number of icons displayed in the task manager view, the size of the icons is prevented from becoming too small. A user would not be able to identify the task to which the icon relates if the icon is too small. Furthermore, the task manager will limit the maximum size of the icon to the size of the icon displayed when there is a single icon in the task manager view.

Although only task manager views 75 showing one, two, three and nine active icons have been shown, the same principles are applicable to the display of four, five, six, seven and eight icons and, in each case, the task manager 51 arranges the active icons on the task manager view 75 in an appropriate manner, analogous to that shown in FIGS. 5 to 8.

For each task manager view, the sizes of the icons are equal. Therefore, layout rules are relatively easy to implement as they may be consistently applied to all icons in the task manager view. Furthermore, in this embodiment, the same scaling rules apply to each icon when an icon is added to, or taken away, from the task manager view.

It is further to be realised that all icons, regardless of the number of icons displayed at the same time, have the same aspect ratio. This allows each icon to represent a reduced, thumbnail rendering of the display the user would experience if that corresponding task were in a foreground mode.

It is also important to note that that the active icons displayed on the task manager view are ordered in a corresponding sequence to the order in which the applications to which the active icons relate were launched. For example, consider the situation in which the user of the device 10 first turns the device 10 on, and then activates the following applications in the following order, a photograph gallery, a calendar and a camera. If the user then activated the button 70 from the camera application view, the layout of the applications would correspond to FIG. 7, wherein three active icons are shown. Moreover, the order of the active icons would correspond to the order in which the three applications were loaded. Therefore, the active icon 74d would represent the photograph gallery, the active icon 74e would represent the calendar and the active icon 74f would represent the camera. Similarly, FIG. 5 illustrates the situation where a single application is running and FIG. 6 the situation where two applications are running. Therefore active icons 74a and 74b would represent the photograph gallery application and active icon 74c the calendar application.

An advantage of operating in this way is that the active icons maintain the same relative order to one another. This makes it easier for the user to locate a running application using its active icon. If an active icon's location could change, the user would have to identify the location of each active icon each time the task manager view was brought to the foreground. This would waste the user's time and lead to a worse user experience. The only exception to this operation is when an active icon is terminated. In this case, the positions of other active icons which are present are adjusted in accordance with the above-mentioned layout rules.

When the user actives the button 70 to move the task manager 51 from the background mode to the foreground mode, one or a number of active icons are displayed in dependence on which applications 44 are running at that time. If during the course of subsequently operating the device 10 the user terminates one or more of those running applications, the next time that the user actives the button 70 (either from an application view or the home view) the active icons corresponding to those terminated applications will not be displayed on the task manager view. In order to enable this functionality the task manager 51 maintains a database 53 of entries for applications 44 which are currently running on the device 10 stored on non-volatile memory 36. More specifically, each time an application is launched, the kernel 50 instructs the task manager 51 to add a corresponding entry to the database 53. Further, each time an application is terminated, the kernel 50 instructs the task manager 51 to remove a corresponding entry from the database 53. Then, when the user selects button 70 to bring the task manager 51 to the foreground, the task manager 51 inspects the database 53 to identify which of the applications 44 are running. Then, the task manager 51 loads an active icon only for those applications which have an entry in the database 53. According to this operation, the task manager 51 is capable of accurately keeping up to date with applications starting and terminating.

In addition to the task manager view 75 providing means for the user to identify, at any chosen time, which applications 44 are running, the task manager view 75 also allows the user to switch running applications. In other words, the task manager view allows the user to switch a running application from a background mode into the foreground mode. More specifically, in FIGS. 5 to 8, each of the active icons 74a to 74o may be selected by suitable means, such as, for example, a user's finger or a stylus tapping on the active icon, to switch the application to the foreground so that the user can continue operating it. For example, a user may start a word processing application and start writing a new document but realise that they require information from the internet in order to finish the document. In this situation, the user may launch an internet browser and begin browsing the internet while the word processing document is still running in the background. While using the browser, the user can select button 70 (from the browser's application view) to bring the task manager 51 into foreground mode. Assuming the user does select button 70, one of the active icons displayed on the task manager 51 will correspond with the running word processing application. According to this embodiment, the user can select the corresponding active icon to switch the word processing application to foreground mode and cause this application to be displayed on the display 16 and allow the user to continue writing the document.

The task manager view 75 also provides a means to interact with running applications in addition to closing and returning them to the foreground. In particular, if two or more active icons are displayed on the task manager view, the active icons may interact with each other by having the task manager 51 instruct the corresponding applications to perform certain operations. For example, assume that four active icons are present, the first active icon representing a browser application, the second active icon representing an address book application, the third active icon representing an instant messenger application, and the fourth active icon representing a photography gallery application. Dragging the browser's active icon onto the instant messaging application's active icon causes a hyperlink to the currently viewed internet page to appear on the current messaging conversation. Additionally, dragging the address book's active icon onto the messaging application's active icon causes an invitation to the current messaging conversation to be sent to the person whose address details are currently displayed by the address book. Additionally, the direction of the dragging operation can determine the operation performed by the task manager 51. For example, dragging the photograph gallery application's active icon onto the browser's active icon causes the current image from the photograph gallery to be opened by the browser. Alternatively, dragging the browser's active icon onto the photograph gallery application's active icon causes the current image from the browser to be stored in the photograph gallery.

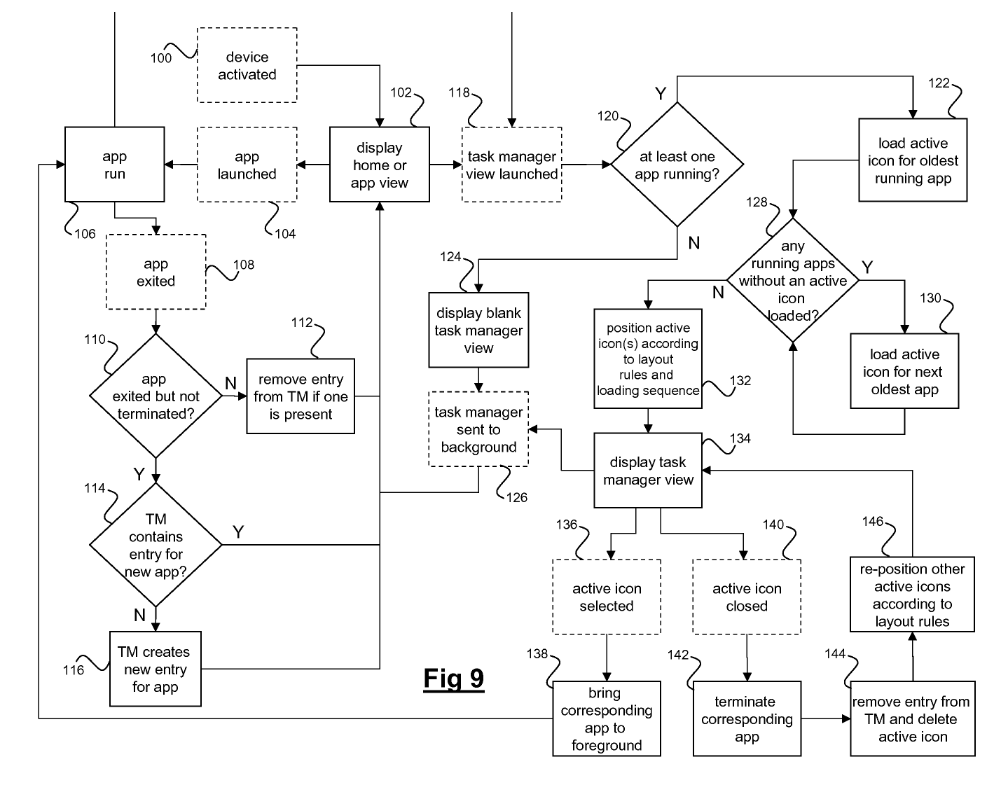

FIG. 9 provides a flow diagram of the operation of an embodiment. It is noted that within FIG. 9, there are three different styles of step. Rectangular-shaped steps with a continuous border indicate processing steps performed by the device 10. Rectangular-shaped steps with a dashed border indicate processing performed as a result of an input received from a user, such as, for example, an interaction between a stylus and the touch screen display 16. Diamond-shaped steps indicate a binary question, wherein the alternative answers to the question are indicated by the letters ‘Y’ and ‘N’ on flow paths leaving the step.

Operation according to FIG. 9 begins at step 100. At step 100, a user of the device 10 turns it on and the device boots up. Once the device is ready for operation processing flows to step 102. At step 102, the device waits in a home view (also know as a desktop) until the user issues another instruction. If the user launches one of the applications 44, such as a word processing application, processing flows to step 104. Once the word processing application has been launched at step 104, processing flows to step 106. At step 106, the word processing application is run by the application processor. For example, the user begins writing a new document. While the application is running, the task manager view may be launched in a manner described below. If this is done, the process will proceed from step 106 to step 118.

Once the user has finished writing or would prefer to start another application, processing flows to step 108. At step 108, the word processing application is exited and processing flows to step 110. Two principle ways in which the user may exit an application are: firstly, the user may terminate the application, i.e. close it down, and secondly, the user may start another application, i.e. move the first application to the background so that it is no longer displayed on the display 16. At step 110, the device 10 determines whether or not the word processing application has been exited but not terminated. If the word processing application has been terminated then processing flows to step 112. At step 112 the kernel 50 requests that the task manager 51 identifies if it has an entry in its database 53 for the word processing application, and if it does, the kernel 50 requests that the task manager removes the entry. Processing then flows back to step 102, wherein the device 10 displays the home view or a different application view (depending on a number of factors such as whether other applications are running and the order in which any other applications were previously accessed). In the present case, the device 10 will display the home view as no other applications are running.

Alternatively, if at step 110 the word processing application (for example) has been moved to the background but not terminated, processing flows to step 114. At step 114, the kernel 50 requests that the task manager 51 identifies whether it already contains an entry in its database 53 for the word processing application. If the task manager 51 does contain an entry, processing flows to step 102, wherein the device 10 displays either the home view or a different application view. For example, if a new application, such as an internet browser, has been launched directly from the first application (e.g. via a hyperlink in a document), at step 102, the device 10 will display the new application's view (i.e. display the browser). Alternatively, if the user exited the first application to start another one from the home view, at step 102, the device 10 will display the home view. If at step 114, the task manager 51 does not contain an entry in its database 53 of the exited word processing application, a new entry is created at step 116. A new entry is created in this instance as the word processing application is being exited but not terminated and therefore, although the user is no longer using the word processing application, it is still running in the background. Processing then flows from step 116 back to step 102, wherein the home view or another application view is displayed, as discussed above.

According to the above operation, the task manager 51 is capable of keeping up to date with which applications are running on the device 10. In particular, all of those applications running in the background will have a corresponding entry in the task manager's database 53.

From step 102, instead of opening a new application a user may decide to launch the task manager view. As mentioned above, the button 70 appears in the top left corner of the home view and each application view and the user can launch the task manager view by activating the button 70. Once the user activates the button 70 processing flows from step 102 to step 118 where the task manager 51 is brought to the foreground and the task manager view 75 is launched. Processing then flows to step 120, wherein the task manager 51 identifies if at least one application is running in the background. The present embodiment performs this operation by identifying if there are any entries in the task manager's database 53. If there are entries then at least one application is running and processing flows to step 122, which is discussed below. Alternatively, if there are no entries in the database 53 then it is determined that no applications are running and processing flows to step 124. At step 124, the task manager displays a blank task manager view 75. More specifically, the user interface displayed comprises a button 76 (FIGS. 5 to 8) but no active icons. The only operation available to the user in this situation is to select button 76 to return the task manager 51 to the background. When the user performs this operation processing flows to 126 and then back to step 102. At step 102, as no applications are running the home view is displayed.

Alternatively, if at step 120 it is determined that there is at least one application running then, as mentioned previously, processing flows to step 122. At step 122, the task manager 51 loads an active icon for the oldest running application. Each time the task manager 51 adds an entry to its database 53 the new entry is added to the end of the current list. Therefore, the task manager 51 is able to identify the order in which the applications are started by inspecting the order of entries in the database 53. At step 122, the task manager 51 loads an active icon for the first entry in the database 53 (i.e. the oldest running application). The process of loading an active icon involves rendering the active icon with an up-to-date representation of the display caused by the corresponding application. For example, the task manager 51 will load an up-to-date screenshot via the kernel 50 and render the active icon with the image. Once the active icon has been loaded, processing flows to step 128. At step 128, the task manager 51 identifies if there are any other running applications. More specifically, the task manager 51 identifies if there are any other entries in its database 53. If there are other applications running, processing flows from step 128 to step 130. At step 130, the task manager 51 loads an active icon for the next oldest application. The process then returns to step 128. Importantly, the order in which active icons are loaded for running applications corresponds with the order in which the applications themselves were loaded. Processing flows in a loop between steps 128 and 130, as long as there are running applications for which an active icon has not been loaded. Once an active icon has been loaded for each running application, processing flows from step 128 to step 132. Alternatively, if only one application is running, processing flow bypasses step 130 and flows directly from step 128 to step 132.

At step 132, the task manager 51 positions all the loaded active icons on the task manager view according to the layout rules mentioned above and ensures that the order of the active icons matches the order in which they were loaded. This order also matches the order in which the corresponding applications were first launched. Once the active icons have been positioned in step 132, processing flows to step 134. At step 134, the task manager 51 displays the task manager view 75 comprising one or more active icons and the button 76, as illustrated by FIGS. 5 to 8.

According to the above operation the user can select the button 70 from the home view or an application view to launch a task manager view 75 comprising an active icon for each application running on the device 10.

From step 134 the user may generate three different operations. Firstly, the user can then exit the task manager view by selecting the button 76 which switches the task manager 51 to the background mode. In this case processing flows from step 134 to step 126, which has been discussed above. Secondly, the user can select any part of an active icon (excluding the top-right portion) to bring the corresponding application to the foreground and enable the user to continue operating the application. In this case processing flows from step 134 to steps 136, 138 and then back to 106. Processing from step 106 is discussed above. Thirdly, the user can select the top-right portion of an active icon to terminate the corresponding application without bringing it back to the foreground. In this case, processing flows from step 134 to steps 140 and 142. Once the corresponding application has been terminated at step 142, processing flows to step 144, wherein the corresponding entry from the task manager's database 53 is removed. This action confirms that the application will not be considered a running application (until it is launched again). The corresponding active icon is also removed from the task manager view 75. Processing then flows to step 146 wherein the remaining active icons on the task manager view are re-positioned in accordance with the layout rules mentioned above, in order to take advantage of the additional space freed up by the removal of one active icon. Processing then flows back to step 134.

According to this operation, the user is able to use the task manager view to identify which applications are running at any given time, bring any one of the running applications to the foreground, and close any one of the running applications without having to bring that application to the foreground. It is an advantage of this embodiment that the user can quickly and effectively manage all running applications from one predetermined display area. Additionally, it is an advantage that because the order of the active icons does not change the user can quickly identify the corresponding active icon for a particular application by remembering its relative location. Additionally, it is an advantage that the user can quickly identify which active icon relates to which running application because the active icon comprises a representation of the display caused by the corresponding application.

The present embodiment is also capable of allowing a user to cause two or more active icons to interact with one another. For example one active icon may be dragged onto another active icon to cause the task manager 51 to perform certain operations, as discussed above.

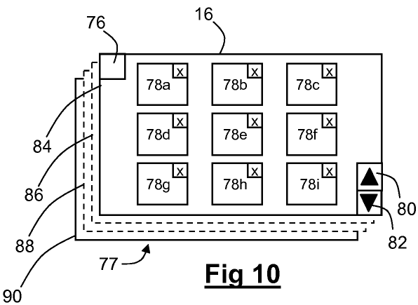

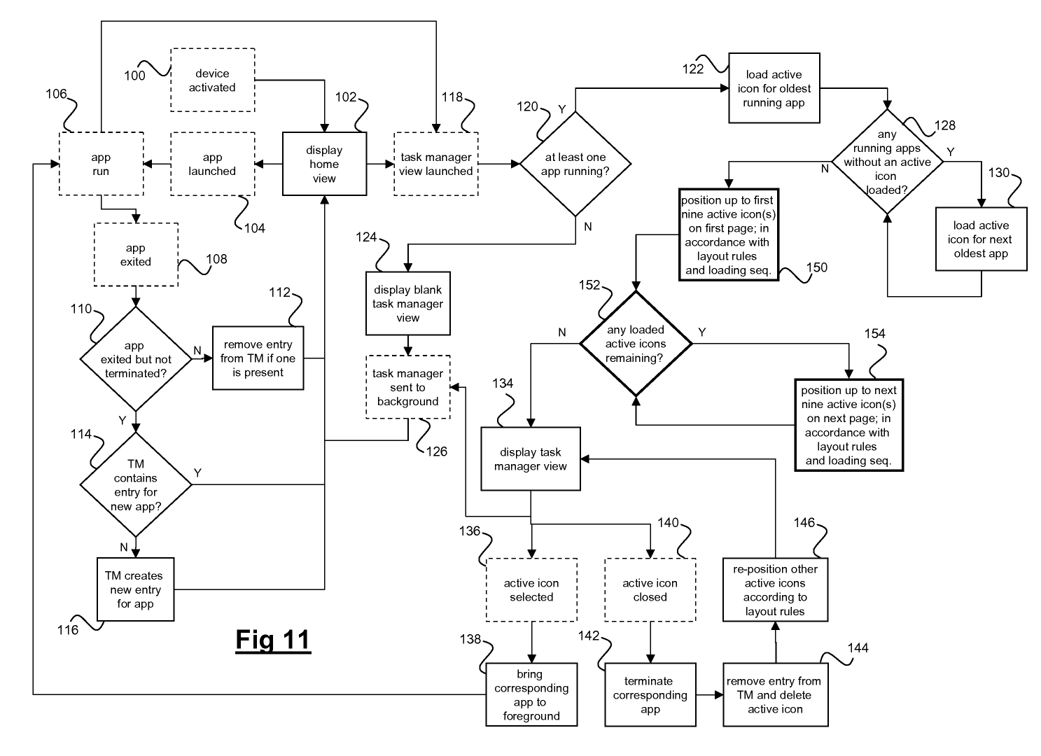

FIGS. 10 and 11 provide a screen shot and flow diagram according to another embodiment. FIG. 10 illustrates a task manager view 77 in multi-page format. In particular, when more than nine applications are running the task manager view spans across a number of different pages, wherein each page may comprise a maximum number of active icons. In the present embodiment the maximum number of active icons is nine. This is illustrated on FIG. 10, wherein a task manager view is shown in multi-page format. In particular, nine active icons are displayed 78a to 78i. Additionally, new buttons 80 and 82 are displayed in the bottom-right corner of the task manager view. The button 80 enables the user to cycle through the different task manager view pages. In FIG. 10, four task manager view pages are shown, 84, 86, 88 and 90. Additionally, the button 82 enables the user to cycle through the different task manager view pages (84, 86, 88 and 90) in the opposite direction to button 80. The number of task manager view pages is dependent on the number of running applications.

In this embodiment, each of the pages 84, 86, 88 and 90 is a predetermined display area in which no more than a maximum number of icons may be displayed.

FIG. 11 provides a flow diagram illustrating how the multi-page format task manager view is generated by the present embodiment. The following describes the aspects of FIG. 11 which are different from FIG. 9. In particular, in FIG. 11, step 132 of FIG. 9 has been replaced by new steps 150, 152 and 154. Therefore, at step 128 once all active icons have been loaded, processing flows to step 150. At step 150, the task manager 51 positions the first nine loaded active icons on the task manager view according to the layout rules mentioned above and ensures that the order of the active icons matches the order in which they were loaded. This operation ensures that the first page contains the active icons for the first nine running applications to be launched. Processing then flows from step 150 to step 152. At step 152 the task manager 51 establishes if there are any more loaded active icons to be positioned. In this embodiment this will only be the case if there are more than nine running applications. If there are more loaded active icons then processing flows from step 152 to step 154, alternatively processing flows from step 152 to step 134, which is discussed above with reference to FIG. 9. If processing flows to step 154, the task manager 51 positions the next nine loaded active icons on the next task manager view page according to the layout rules mentioned above and ensures that the order of the active icons matches the order in which they were loaded. This operation ensures that the second page contains the active icons for the tenth to eighteenth running applications launched. Processing then flows from step 154 back to step 152 and will continue to flow in a loop around these two steps so long as there are loaded active icons which have not been positioned on a task manager view page. Once all loaded active icons have been positioned on a page, processing flows from step 152 to step 134, which is discussed above with reference to FIG. 9.

It is an advantage of this embodiment that any number of active icons may be displayed on the task manager view. Although FIG. 10 illustrates four pages, the number of pages will be determined by the number of active icons to be displayed and pages are created at step 154 as desired.

As before, the order of the active icons on a page does not change thereby enabling the user to quickly identify an active icon. The only exception to this rule occurs when active icons are terminated. In this case, remaining active icons are moved to fill in the empty space, but their relative positions will remain the same.

According to the present embodiment, when the button 70 is activated by the user, the task manager view page which was last viewed by the user is the one to be brought into foreground mode. To do so, the task manager 51 keeps a record of the page last viewed by the user. If the user has not viewed any page previously, the first page is loaded, which contains the first running applications to be launched. An advantage of this operation is that the user is able to locate the active icon relating to a particular task more quickly and this leads to an improved user experience.

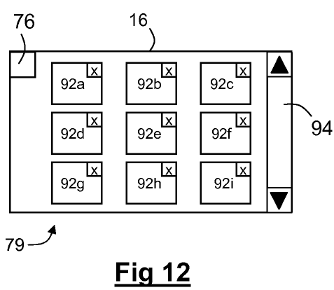

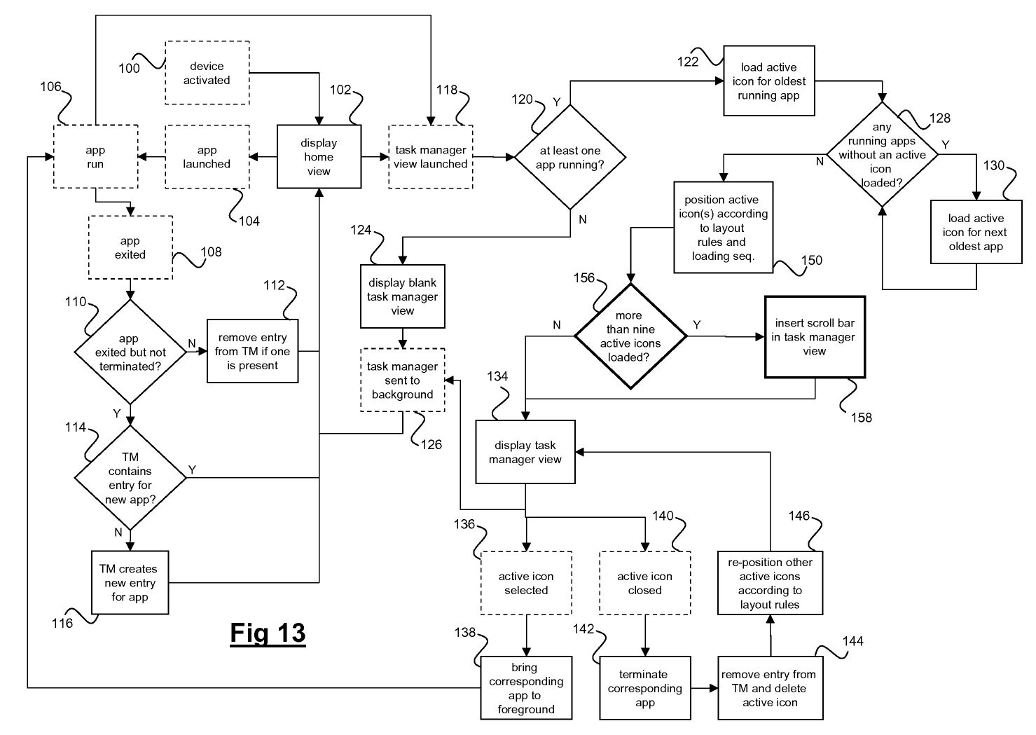

FIGS. 12 and 13 provide an exemplary screen shot and flow diagram according to another embodiment. FIG. 12 illustrates a task manager view 79 in scroll-page format. In particular, when more than nine applications are running the task manager view 79 may increase in length to accommodate more than nine active icons. The user may navigate around the page using a scroll bar, as is well known in the art. This is illustrated on FIG. 10, wherein a task manager view 79 is shown in scroll-page format. In particular, nine active icons are displayed 92a to 92i. Additionally, a scroll bar 94 is displayed along the right-hand edge of the task manager view 79 for scrolling the task manager view.

In this embodiment, the predetermined area comprises that portion of the task manager view 79 which is displayed at any one time and which contains no more than nine active icons.

FIG. 13 provides a flow diagram of how the scroll-page format task manager view 79 is generated by the present embodiment. The following describes the aspects of FIG. 13 which are different from FIG. 9. In particular, in FIG. 13, new steps 156 and 158 have been added in between steps 132 and 134 of FIG. 9. Therefore, at step 132 once all active icons have been positioned, processing flows to step 156. At step 156, a determination is made whether more than nine active icons have been positioned and, if so, processing flows to step 158. Alternatively processing flows to step 134, which is discussed above with reference to FIG. 9. At step 158, the task manager 51 inserts a scroll bar 94 in the task manager view to enable the user to scroll the task manager view 75. Processing then flows to step 134, which is discussed above with reference to FIG. 9.

It is an advantage of this embodiment that any number of active icons may be displayed on the task manager view 79. As before, the order of the active icons does not change to enable the user to quickly identify an active icon. The only exception to this rule is that when active icons are terminated, remaining active icons are moved to fill in the empty space, but their relative order remains the same.

According to the present embodiment, when the button 70 is activated by the user, the portion of the task manager view 79 which was last viewed by the user is the one to be brought into foreground mode. To do so, the task manager 51 retains a record of the portion of the task manager view 79 last viewed by the user. If the user has not viewed the task manager view previously, the first portion is loaded, which contains the first running applications to be launched. An advantage of this operation is that the user is able to locate the active icon relating to a particular task more quickly and this leads to an improved user experience.

In the embodiments discussed above the task switcher button 70 comprises a software button positioned in a top-left portion of the display 16 in a landscape orientation. In alternative embodiments the button 70 is positioned elsewhere on the display 16, such as, in a bottom-right portion. Furthermore, in further embodiments the button 70 is a hardware button, positioned within the keypad 14 or positioned elsewhere on the device 10. Further still, such a hardware button could be provided by a pre-existing button or a newly designated button.

In the embodiments illustrated, the kernel 50 is only able to display the output of a single task to the user at any one time (with the exception of the multiple icons which may be provided by the task manager 51). In an alternative embodiment, the kernel 51 is able to simultaneously display the output of a plurality of tasks, the output of each task being presented in a separate ‘window’. In this alternative embodiment, the task manager view will remain as depicted in FIGS. 5 to 8 and each icon will correspond to a currently-open window. However the sizes of windows may vary and therefore each icon may be only a portion of the window which would be visible if the corresponding task were in the foreground. By cropping the representation of a window, each icon of a particular task manager view may retain the same size and shape, ensuring that the icons may be arranged in the manner described in the illustrated embodiments. Furthermore, it is not necessary to change the aspect ratio of any of the icons in this embodiment.

In a further embodiment, the task manager 51 provides a user interface in which a user may customise the manner in which the task manager operates. For example, the user may specify the maximum number of icons permitted in a task manager view or page. Alternatively, the user may specify the minimum and/or maximum sizes for an icon.

What is claimed is:

1. Apparatus comprising a task manager and a display, said task manager being configured to:
designate a predetermined display area for displaying representations of tasks on said display; and
display a representation of each of a plurality of tasks in said predetermined display area, wherein each of said representations is a representation of a display caused by said corresponding task, and wherein no more than a predetermined maximum number of representations is displayed in said predetermined display area.

2. The apparatus according to claim 1 wherein a size of said predetermined display area is independent of a number of representations of tasks displayed.

3. (canceled)

4. The apparatus according to claim 1 wherein said predetermined maximum number of representations is nine.

5. The apparatus according to claim 1 wherein a position of each of said representations in said predetermined display area is dependent on a number of representations of tasks displayed in said predetermined display area.

6. The apparatus according to claim 1 wherein a size of one or more of said representations is dependent on a number of representations of tasks displayed in said predetermined display area.

7-9. (canceled)

10. The apparatus according to claim 1 wherein one or more of said representations of said tasks is a reduced representation of the display caused by said corresponding task.

11. The apparatus according to claim 1 wherein said task manager is configured to affect a status of a task when a user interacts with a representation corresponding to said task.

12. The apparatus according to claim 11 wherein said task manager is configured to open or terminate the task by interacting with the representation corresponding to the task.

13. The apparatus according to claim 1 wherein said task manager is configured to assign a first representation to a first task and a second representation to a second task and cause said first task to interact with said second task when a user causes said first representation to interact with said second representation.

14. The apparatus according to claim 13 wherein said interaction occurs when a user drags said first representation onto said second representation.

15. The apparatus according to claim 1 wherein said task manager is configured to be switched between a foreground mode in which a predetermined display area is visible and a background mode in which no predetermined display area is visible.

16-18. (canceled)

19. A method of representing a plurality of active tasks in a computing device said computing device having a display, said method comprising: designating a predetermined display area for displaying representations of tasks on said display; and displaying a representation of each of a plurality of tasks in said predetermined display area, wherein each of said representations is a representation of a display caused by said corresponding task, and wherein no more than a predetermined maximum number of representations is displayed in said predetermined display area.

20. The method according to claim 19 wherein a size of said predetermined display area is independent of a number of representations of tasks displayed.

21. (canceled)

22. The method according to claim 19 wherein said predetermined maximum number of representations is nine.

23. The method according to claim 19 wherein a position of each of said representations in said predetermined display area is dependent on a number of representations of tasks displayed in said predetermined display area.

24. The method according to claim 19 wherein a size of one or more of said representations is dependent on a number of representations of tasks displayed in said predetermined display area.

25-27. (canceled)

28. The method according to claim 19 wherein one or more of said representations of said tasks is a reduced representation of the display caused by said corresponding task.

29. The method according to claim 19 further comprising affecting a status of a task by interacting with a representation corresponding to the task.

30. The method according to claim 29 further comprising opening or terminating the task when a user interacts with the representation corresponding to the task.

31-36. (canceled)

37. A memory medium storing a computer program executable by a processor of a computing device, said computing device having a display and a plurality of tasks operating thereon, said computer program performing operations when executed by said processor, said operations comprising: designating a predetermined display area for displaying representations of said tasks on said display; and displaying a representation of each of a plurality of tasks in said predetermined display area, wherein each of said representations is a representation of a display caused by said corresponding task, and wherein no more than a predetermined maximum number of representations is displayed in said predetermined display area.

38-59. (canceled)
